(19) United States
(12) Patent Application Publication
(10) Pub. No.: US 2009/0192422 A1
(43) Pub. Date: Jul. 30, 2009

(54) Handheld Massagers and Methods of Operation

(75) Inventors: Victor Lee Walker, Murrieta, CA (US); Angelo Vito Pugliese, JR., Vista, CA (US)

Correspondence Address: FITCH EVEN TABIN & FLANNERY, 120 SOUTH LASALLE STREET, SUITE 1600, CHICAGO, IL, 60603-3406, US

(73) Assignee: DIMENSION ONE SPAS, INC., Vista, CA (US)

(21) Appl. No.: 12/021,858

(22) Filed: Jan. 29, 2008

(51) Int. Cl. A61H 1/00

(52) U.S. Cl. 601/46

(57) ABSTRACT

Handheld massagers for providing hydrotherapy and/or vibratory or pulse massage therapy are disclosed, as well as methods for use of such massagers. The handheld massager can be connected, such as by using a single hose, to a primary fluid supply of a pool or spa. The handheld massager may be configured to provide for multiple different gripping positions and may have attachments that can facilitate providing vibratory massage, such as by direct contact with a body part of a user or someone else.

### FIELD

This disclosure relates generally to handheld massagers that have fluid jets and methods of operation, and in particular to handheld massagers that have fluid jets supplied with fluid from a fluid source of a pool or spa.

### BACKGROUND

Pools and spas typically have a plurality of jet assemblies for directing fluid into the body of water. A user can position themselves in front of the jet assemblies to direct the fluid exiting the jet assemblies onto specific parts of their body to provide hydrotherapy. Due to the submerged positions of the jet assemblies, however, the number of specific body parts of the user that can be positioned in front of the jet assemblies is limited. Moreover, it may be uncomfortable for users to position certain body parts in front of the jet assemblies. To expand the capabilities of hydrotherapy using jet assemblies of pools and spas, devices have been provided to connect to the jet assemblies and provide remote fluid flows that can be more specifically directed upon specific body parts.

One such example of a device that can be connected to the jet assemblies of a pool or spa to provide remote fluid flows is made by HydroAir. That handheld device has a pistol-type grip. Two hoses are connected at one end of a handle, one for supplying air and another for supplying liquid. The fluid exits the handheld device through a jet positioned at about a 90 degree angle relative to the handle. In order to activate and maintain the fluid flow, an actuator must be depressed toward the handle. There are several disadvantages to this design. The pistol-type grip limits the number of different gripping positions of the device and the use of two different supply hoses can result in increased tangles, particularly when compared to a single supply hose. These disadvantages can limit the capabilities of the device. Furthermore, the 90 degree turn that the fluid flow must make can cause a decrease in fluid pressure. That in turn can lead to a decreased pressure fluid stream exiting the jet. This can be particularly problematic when the device is used under water, where the water will dampen the fluid stream. The use of such a continually depressed actuator can cause fatigue in the hand of the user, making use of the device uncomfortable after a period of time. Further, the comparatively narrow configuration of the actuator could lead to fatigue in the hand of a user of extended periods of use, in particular due to tissue compression.

Another device that can be connected to the jet assemblies of a pool or spa to provide remote fluid flows is made by Waterway Plastics, of Oxnard, Calif. That device has a single hose that supplies fluid to a handheld unit having a handle portion intersecting a jet portion at an obtuse angle. However, the jet portion has an enlarged diameter compared to the handle portion, thereby potentially limiting the gripping positions to those involving the handle portion. Furthermore, the uniformity of the handle portion could lead to fatigue in the hand of a user over extended periods of use, in particular due to tissue compression of a user's hand, including compression of the thenar pad.

Another device provides simply a nozzle that is attached to extendable and retractable tubing, such as disclosed in U.S. Pat. No. 6,131,212. When retracted, the nozzle can function as one of the submerged jets of the spa. When extended, the user can grasp the tubing and direct the nozzle for remote fluid flows. However, the tubing does not have any specific provisions made to facilitate gripping and control by a user.

### SUMMARY

Handheld massagers for providing hydrotherapy and/or vibratory or pulse massage therapy are disclosed, as well as methods for use of such massagers. The handheld massager can be connected, such as by using a single hose, to a primary fluid supply of a pool or spa. The handheld massager may be configured to provide for multiple different gripping positions, thereby increasing the capabilities of the massager for providing therapy to specific body parts of a user or someone else. The gripping positions may be ergonomically configured to reduce fatigue during use, and may be shaped to accommodate a wide range of user hand sizes. The handheld massager may also be configured to provide for improved fluid flows, and thereby increased fluid pressures. The handheld massager also can have reduced numbers of parts, and in particular moving parts, to increase the durability of the massager. In addition, the handheld massager may have attachments that can facilitate providing vibratory massage, such as by direct contact with a body part of a user or someone else.

In order to provide for multiple gripping positions, the handheld massager may include a housing having a first segment, adjacent a jet assembly of the massager, and a second segment. The first and second segments may be positioned at an obtuse angle to each other, and may be joined by a curved segment. The cross-sections of all of the segments may be selected to fit in the hand of typical users, and may be ovular. Thus, a user can grip either the first or second segments, or even part of the first or second segments and the curved segment. One or more of the segments may have an indentation for receiving a user's thenar pad to facilitate comfortable use of the handheld massager. A jet of the massager can be directed using a wand-like grip with the jet pointed outwardly from the hand or a fist-like grip with the jet pointed downwardly from the hand, thereby increasing the versatility of the massager. The second segment may be configured for wand-like gripping, and may have a curved region in order to provide a recess for the user's thenar pad. The first segment may have a larger cross-section and be configured for fist-like gripping, with the jet assembly on an opposite side of the hand from the thumb and with the curved segment providing a recess for the user's thenar pad. A rubberized pattern may be applied to the exterior of the housing, both to provide a pleasant feeling grip and to reduce slippage in a water environment.

The hose may be connected to a jet assembly of the massager internal of the housing. The obtuse angle between the first and second segments of the housing, as well as the curved intermediate segment, provide a guide for the hose internal of the housing that can reduce kinks and the like in the hose, and thereby provide for a more consistent flow of fluid to the jet assembly and exiting the jet assembly in a fluid stream. Control of the fluid flow may be accomplished using the jet of the pool or spa, thereby reducing the number of parts of the handheld massager, as well as eliminating the need for an actuator that must be continually depressed to activate the fluid stream. Alternatively, control of the fluid flow may be accomplished using a selectively depressible button or the like on the housing. If such control is provided on the housing, it preferable is configured to not require continuous depression in order to active the fluid flow.

The handheld massager may also have an end adapted for direct contact with a body part of a user or someone else. The end may be rigid plastic, or may be made of an elastic or softer material, depending upon the intended use and user preferences. The end may be integrally formed with the housing, or may be in the form of a massage head that can be attached to the housing. The use of such an end can permit the handheld massager to be used for vibratory or pulse massaging.

In one aspect, the handheld massager may be adapted to mate with a removable massage head. A plurality of different massage heads can then be provided for use with the handheld massager. The massage heads can be configured to provide for different sensations during use, or to be tailored for use with specific body parts. The massage heads can be attached to the housing in a manner that causes the massage heads to vibrate, oscillate or the like in response to fluid flow. Instead or in addition, the massage head can vibrate due to the type of jet assembly used, such as a jet assembly having a jet that rotates in response to fluid flow.

### BRIEF DESCRIPTION OF THE DRAWINGS

FIG. 1 is a perspective view of a handheld massager having a housing and a jet assembly and a hose connecting the handheld massager to a fluid source of a pool or spa;

FIG. 2 is a perspective view of the handheld massager of FIG. 1 and partially showing the hose;

FIG. 3 is a side elevation view of the handheld massager and hose of FIG. 2;

FIG. 4 is a cross-sectional view of the handheld massager of FIG. 3 taken along a plane parallel to the side elevation view and through the center of the handheld massager, showing the housing, the hose and the jet assembly;

FIG. 5 is a side elevation view of the handheld massager of FIG. 2 with a massaging head attached to an end of the housing having the jet assembly;

FIG. 6 is a cross-sectional view of the handheld massager of FIG. 5 taken along a plane parallel to the side elevation view and through the center of the handheld massager, showing the housing, the jet assembly and the massaging head;

FIG. 7 is an exploded view of the handheld massager and jet assembly of FIG. 2 and the massaging head of FIG. 5;

FIG. 8 is an exploded view of the handheld massager and jet assembly of FIG. 2 together with an alternative massaging head having a pivotal attachment;

FIG. 9 is a side elevation view of a handheld massager having a housing and a jet assembly with an activation switch and a removable massaging head;

FIG. 10 is a side elevation view of a handheld massager being gripped by a hand on a rearward portion of the massager;

FIG. 11 is a side elevation view of a handheld massager being gripped by a hand on a forward portion of the massager;

FIG. 12 is a perspective view of a pivotable massaging head for removable attachment to a handheld massager;

FIG. 13 is a sectional view of the pivotable massaging head of FIG. 10 taken along line 11-11 of FIG. 10;

FIG. 14 is a section view of a portion of a jet assembly adapted for use with the massaging head of FIG. 10;

FIG. 15 is a top plan view of the portion of the jet assembly of FIG. 12;

FIG. 16 is a side elevation view of a removable massaging head for use with a handheld massager; and

FIG. 17 is a side elevation view of another removable massaging head for use with a handheld massager.

### DETAILED DESCRIPTION OF THE DRAWINGS

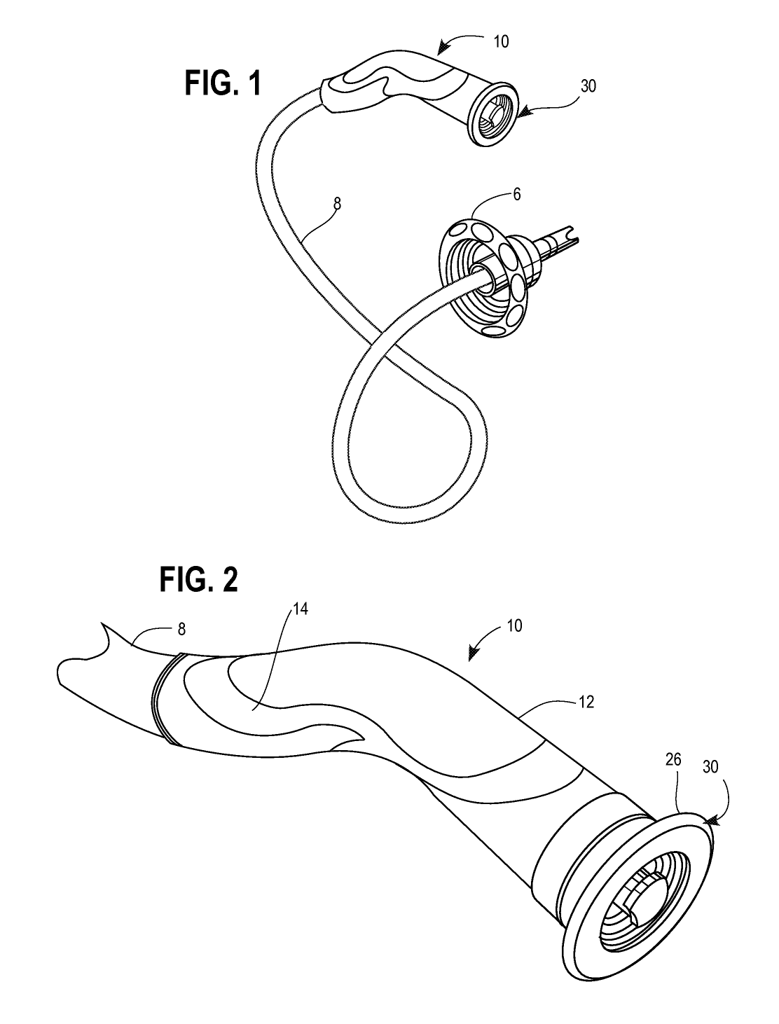

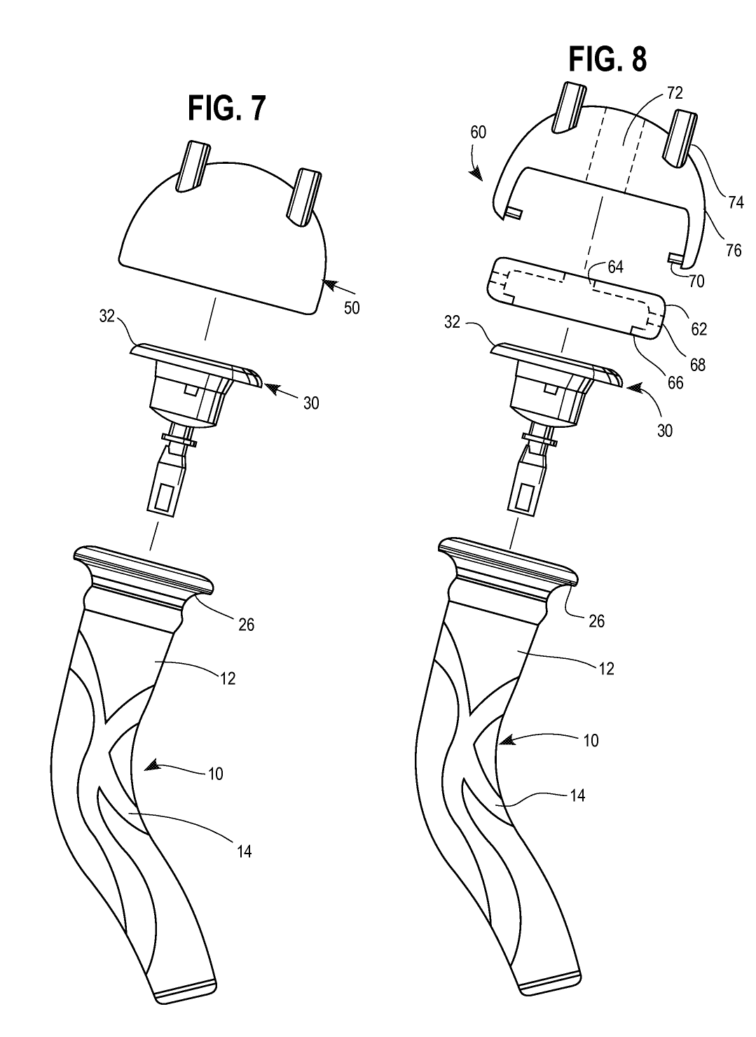

A handheld massager 10 and components thereof are disclosed herein and illustrated in FIGS. 1-17. The handheld massager 10 is advantageously configured to provide multiple, ergonomic gripping positions to provide improved user interaction with the massager 10, to provide improved fluid flow, including increased flow pressures, and to provide hydrotherapy and/or vibratory or pulse massage therapy. In addition, the handheld massager 10 may be configured with minimal moving parts, thereby improving the durability and ease of use for operation.

The handheld massager 10 is adapted to be connected using a hose or the like 8 to a primary fluid source of a pool or spa in order to take advantage of that fluid source. The primary fluid source may be the piping of the pool or spa, or an outlet thereof. In particular, the hose 8 may be connected to a jet assembly 6 of the pool or spa. In one aspect, the hose 8 may be provided already connected to a jet assembly 6 that can be substituted for an already existing jet assembly of the pool or spa. In another aspect, the hose 8 may be adapted, or may include an attachment, to permit attachment to an already existing jet assembly of the pool or spa. This permits the massager 10 to be supplied with fluid directly from the primary fluid source. If that fluid source includes a mixture of air and liquid, a single hose 8 can advantageously be utilized to supply the mixture to the massager 10.

The handheld massager has a housing 12 having a jet assembly 30 at one end and adapted to receive a hose 8 at an opposite end, as illustrated in FIGS. 1 and 2. The hose 8 is connected to the jet assembly 30 internally of the housing 12. In operation, fluid is supplied from the primary fluid source of the pool or spa, through the hose 8 to the jet assembly 30, and then is directed in a stream outwardly from the jet assembly 30. The fluid stream can be directed onto specific muscles, joints or the like to provide hydrotherapy. Depending upon the configuration of the handheld massager 10, the fluid flow can cause vibrations to the massager 10 that can be directly applied to specific muscles, joints or the like to provide vibratory massage therapy.

The housing 12 is hollow, having a first segment 20, adjacent the jet assembly 30, and a second segment 16, as illustrated in FIGS. 2-4. The segments 16 and 20 are joined via an intermediate curved segment 18. The segments 16 and 20 are also angularly spaced from each other at an obtuse angle θ, as measured from an axis of each of the segments 16 and 20. The end of the first segment 20 adjacent the jet assembly 30 has an opening 24 for receiving a portion of the jet assembly 30 internal to the housing 12, and the opposite end of the second segment 16 has an opening through which the hose 8 exits. The arrangement of the segments 16, 18 and 20 advantageously provides for multiple gripping locations, as described in greater detail herein. In addition, the arrangement of the segments 16, 18 and 20 advantageously provides for an internal pathway for the hose 8 that lacks sharp angles that can unduly restrict flow through the hose 8. In particular, the curved segment 18 provides a gradual transition between the first and second segments 20 and 16 for the hose 8, when the hose 8 extends therebetween.

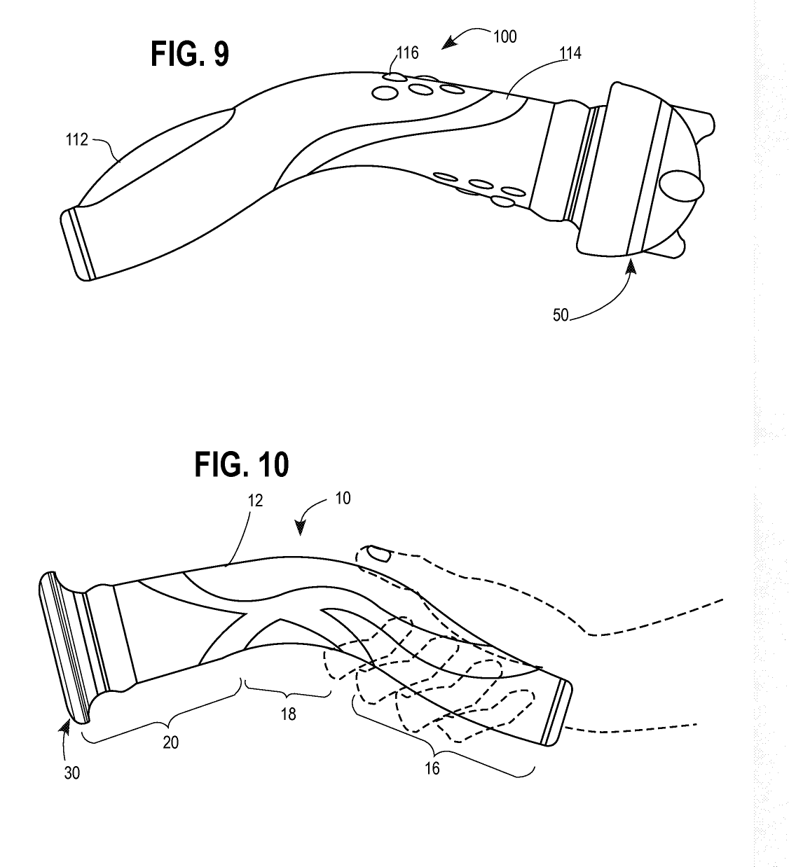

The jet assembly of the pool or spa may be utilized to control the fluid flow to the handheld massager 10, as opposed to having the fluid flow control on the massager 10. However, some or all of the fluid control may be performed using controls on the massager 10. For example, the jet assembly 30 may be rotatably activatable, such that rotation can open or close the flow path. In another example of a fluid control on an alternative massager 100, a selectively depressible button 112 or the like can be used to turn the flow on and off, or to vary the volume of the fluid flow (e.g., low, medium, high), such as illustrated in FIG. 9. The button 112 preferably does not have to continually be depressed in order to activate or deactivate the fluid flow. The button 112 can be connected to a mechanism that pinches the hose to control flow therethrough, to a valve having the hose connected thereto that is opened or closed upon depressing the button 112, or other such internal flow control devices.

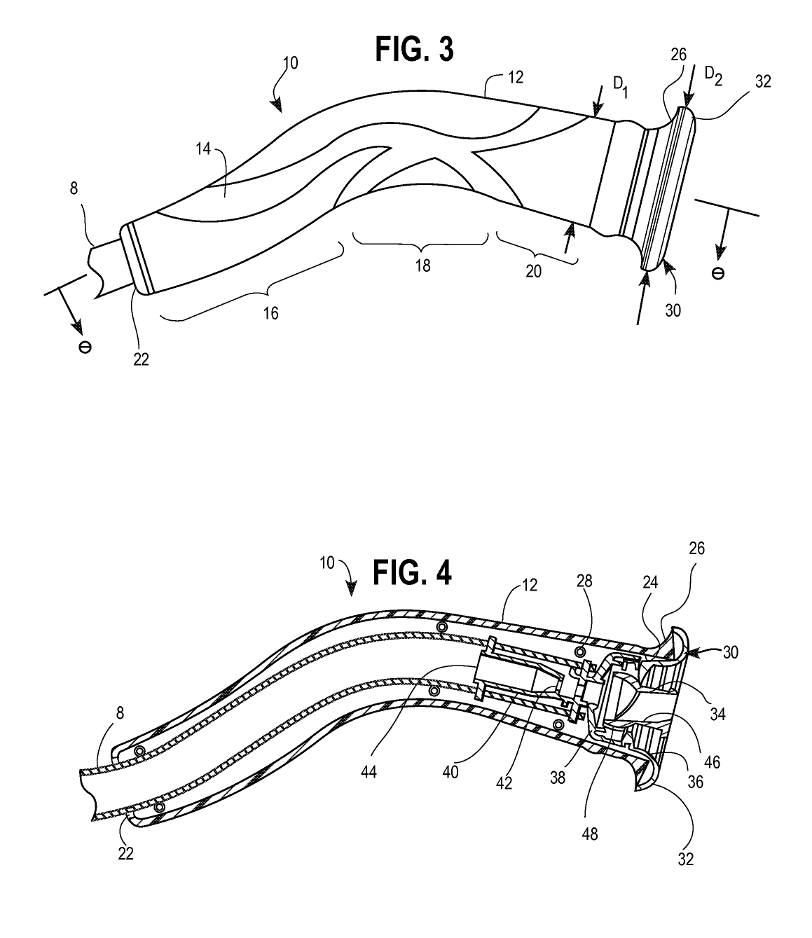

The housing 12 includes an outwardly extending radial flange 26, positioned between the first segment 20 of the housing 12 and the jet assembly 30. The flange 26 can be used to support a generally corresponding flange 32 of the jet assembly 30, as illustrated in FIGS. 3 and 4. The flange 26 of the housing can also be used in conjunction with an attachment, such as for providing vibratory massage, as will be discussed in greater detail herein.

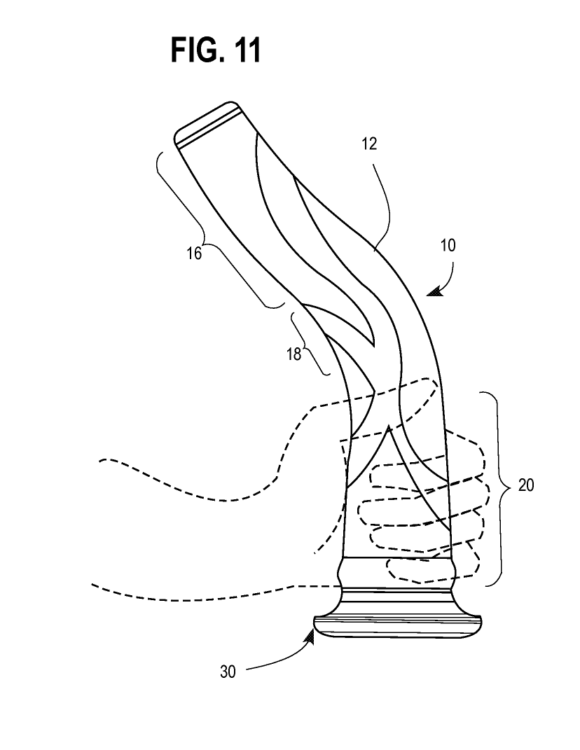

The housing 12 is configured to have multiple gripping positions in order to facilitate use of the handheld massager for both self-therapy and for therapy applied to someone else. The segments 16, 18 and 20 are each preferably generally ovular in cross section, with cross-sections sized to fit in the hand of the users. The term “generally circular”, as used herein, includes ovular cross-sections. In one gripping position, a user can grasp the first segment 20 using a fist, with the jet assembly 30 pointing either downwardly or upwardly relative to the fist, as illustrated in FIG. 11. In another gripping position, a user can grasp the second segment 16 and aim the jet assembly 30 to direct the fluid flow exiting the jet assembly 30, as illustrated in FIG. 10. In particular, the housing 12 is adapted to facilitate both a finger-palm enclosure by a user and a power grasp by a user. For the finger-palm enclosure, most, or all, of the inner surface of the user's hand is in contact with the housing 12 while enclosing it. For this type of enclosure, for example, the second segment 16 can be grasped in a wand-like arrangement. For the power grasp, the total inner surface of the user's hand can grasp the housing 12 which runs parallel to the knuckles. For this type of grasp, for example, the first segment 20 can be grasped in a fist-like manner. The shape of the housing 12 promotes these gripping positions, which can assist in avoiding less desirable gripping positions that may cause unnecessary muscle fatigue during use of the massager 10. Other gripping positions are available depending upon the user's preferences for comfort and for use of the handheld massager, and can include the intermediate curved segment 18 in combination with one or both of the first and second segments 20 and 16.

In order to facilitate gripping, the exterior of the housing 12 may have gripping formations thereon. The gripping formations may be ribs, protrusions or the like. Alternatively, or in combination, the gripping formations may be a material applied to the exterior of the housing 12 and having a different texture than the housing 12. For example, a rubberized material 14 may be overmolded to the housing 12 to provide a gripping formation of stripes or bands, as illustrated in FIGS. 2, 3, 5, 7 and 8. In the alternative housing of FIG. 9, the rubberized material may be in stripes or bands 114, as well as raised bumps 116. The use of such a material can provide for an increased coefficient of friction between the user's hand and the massager 10, while not having a coefficient of friction of such an amount so as to make use of the massager 10 difficult or uncomfortable. In one specific example, the rubberized material 14 may be a thermoplastic elastomer (TPE), such as DYNAFLEX® G7950-9001-02 from GLS Corp., Thermoplastic Elastomers Division, and the housing 12 may be an injection-molded acrylonitrile butadiene styrene (ABS), such as PORENE® ABS SP 100 from Thai Petrochemical Industry Co., Ltd. Whether these specific rubber and plastics are used or others, the materials are preferably selected to be able to withstand the chemical and UV environment typical of pools and spas.

Turning now to more of the details of one example of the jet assembly 30, the jet assembly 30 has a jet 34 for discharging fluid from the handheld massager 12. With reference to FIG. 4, the jet assembly 30 includes an internal portion disposed within the housing 12 and an external portion disposed outside the housing 12. More specifically, the jet assembly 30 has a flange 32 extending radially outward from side walls 36. The side walls 36 are connected to a cup 38, which in turn has an inwardly extending stem 40. The stem 44 is configured to have the hose 8 fit at least partially thereover. A cable tie or other suitable fastenings, including adhesives, may be used to secure the hose 8 to the stem 44. The stem 44 has an open end 44 for receiving fluid from the hose 8, as well as an optional side port 42 for also receiving fluid from the hose 8. The fluid may be liquid, such as water, or, more preferably, a combination of air and liquid. The stem 44 may also have a nozzle segment for accelerating the flow of fluid therethrough and to the jet 34.

The jet 34 may fixed, with the exiting fluid being capable of use for hydrotherapy. The jet 34 may optionally be of the type that rotates in response to fluid flow. Having a rotating jet 34 can advantageously provide for both a variable steam of fluid exiting the jet 34 for hydrotherapy, as well as imparting a vibratory motion to the jet assembly 30 or attachments, which will be described in greater detail, in order to provide vibratory therapy. When the handheld massager 10 is used for vibratory therapy, components or attachments of the massager 10, as will be discussed in greater detail herein, can be contacted with specific body parts for massaging. The rotating jet 34 may have a ball end 48 adapted to be received in a corresponding socket formed in or between the sidewalls 36 and the cup 38 of the jet assembly 30. The jet 34 may have an offset or inclined passage 46 to cause rotation in response to fluid flow therethrough. In one example, the jet assembly 30 may be of the type readily available for use in pools and spas, such as part no. 961235 available from Pentair. The jet assembly 30 may be modified by placing the side port 42 on the stem 40. Flow rates through such jet assemblies are believed to be in the range of about 11-13 GPM at about 15 psi, which can provide a suitable fluid stream both above the water level and below the water level of the pool or spa. Of course, the flow rate is dependent in part upon the flow rate of the primary fluid source of the pool or spa to which the handheld massager 10 is connected. Although a specific example of a jet assembly 30 is described herein, other suitable jet assemblies can be readily incorporated into the handheld massager 10 in its place.

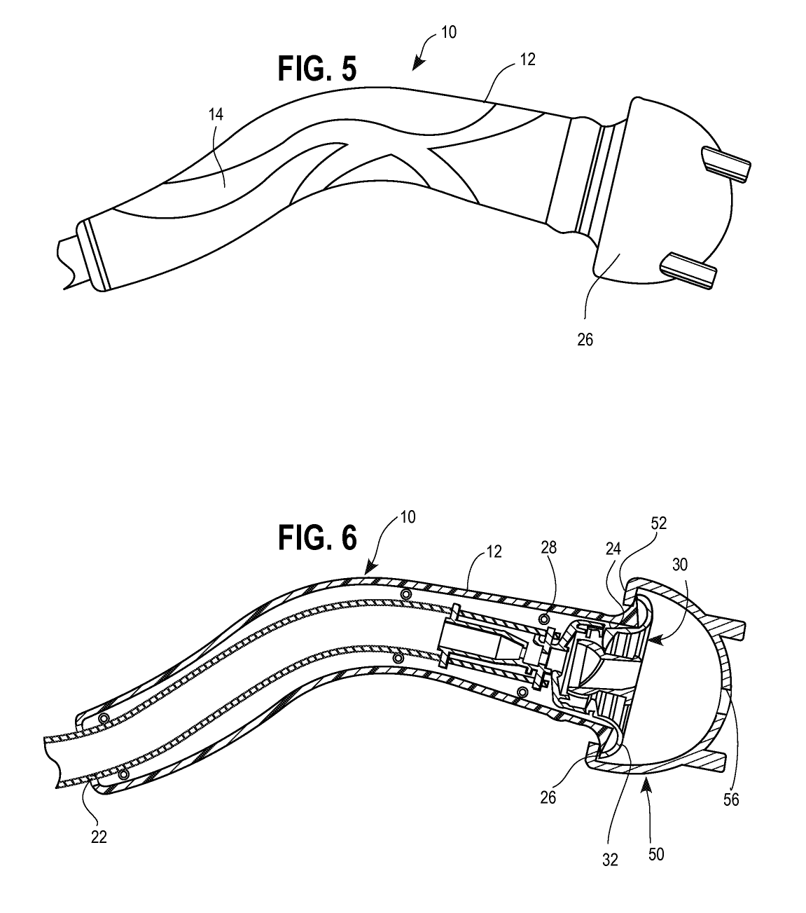

Turning now to more of the details for providing vibratory massage, attachments in the form of massaging heads 50, 60, 80, 90 and 120 may be attached to the end of the housing 12 having the jet assembly 30, as illustrated in FIGS. 5-9. The massaging heads are preferably removable, so that different configurations of massaging heads can be available for use with the handheld massager 10. For example, different massaging heads adapted for massaging different parts of the body can be provided. The massaging head may have one or more openings to permit fluid to exit therefrom for hydrotherapy, as well as have protrusions, ribs or the like for contacting body parts to provide vibratory therapy. The massaging head may be made entirely from a rubber material that has elasticity, such that it can be stretched to fit over the flange 26 of the housing 12 and the flange 32 of the jet assembly 30. Alternatively, the massaging head may be made of a rigid plastic with a comolded elastic rubber base to permit the base to stretch to be placed on the massager 10. Once positioned at least partially past the flanges 26 and 32, the massaging head may elastically return to approximately its pre-stretched state and be maintained on the housing 12.

In a specific example illustrated in FIGS. 5-7, the massaging head 50 is generally dome-shaped with a hollow interior. The base of the dome is open, but has an inwardly extending radial flange 52. The flange 52 define an opening with a diameter less than the diameter of the flange 26 of the housing 12 and the flange 32 of the jet assembly 30, but larger or close to the diameter of the portion of the housing 12 adjacent the jet assembly 30. The massaging head 50 can be stretched or otherwise deformed to permit the flange 52 thereof to slip past the flanges 26 and 32, whereby the flanges 52 of the massaging head 50 can elastically return to or close to its original configuration. The flange 52 of the massaging head 50 can limit removal of the massaging head 50 from the housing 12 in the direction of fluid flow via abutment between the flange 52 of the massaging head 50 with the flange 26 of the housing 12 and/or the flange 32 of the jet assembly 30. In this manner, the massaging head 50 can be retained on the housing 12 during operation. The apex of the dome of the massaging head 50 has an opening 56 to permit fluid to exit the massaging head 50, such as for purposes of hydrotherapy. Although one such opening is illustrated, the opening may be located in any suitable position on the massaging head 50 and a plurality of openings may be provided. The size of the opening 56 can be varied depending upon the type of fluid flow desired. For instance, if it is desired to increase the velocity of the fluid exiting the opening 56, the opening 56 can be of a reduced diameter. Conversely, if it is desired to decrease the velocity of the fluid exiting the opening 56, the opening 56 can be of an increased diameter. The exterior of the massaging head 50 may have raised protrusions or nubs 54, four in the illustrated example but other numbers, shapes and sizes can be equally suitable, depending upon the intended use of the massaging head 50. The protrusions 54 can be pressed against a body part, such as during hydrotherapy and/or vibratory therapy.

Another example of a massaging head is illustrated in FIG. 8. In this example, the massaging head 60 includes a component 62 adapted to be attached to the housing 12, with flanges 66 operating in a similar manner to the flanges 52 of the massaging head 50 discussed above. However, the massaging head 60 also includes an attachment 76 that can be pivotably attached to the component 62 via pins 70 of the attachment 76 insertable into recesses 68 of the component 62. Fluid passages 64 and 72 are provided in the component 62 and the attachment 76, respectively, to permit a fluid stream exiting the jet assembly 30 to be directed through the massaging head 60. The jet assembly 30 and/or the fluid passages 64 and 72 can be configured to have a fluid stream that impacts the attachment 76 in such a manner so as to cause the attachment 76 to reciprocally pivot with respect to the component 62 attached to the housing 12. This reciprocal motion can be particularly useful in providing an oscillating stream of fluid for hydrotherapy, and for providing enhanced vibration for vibratory therapy. For instance, the reciprocating or pivoting motion of the attachment 76 can cause protrusions 74 thereon to be brought into and out of contact with a body part for massaging.

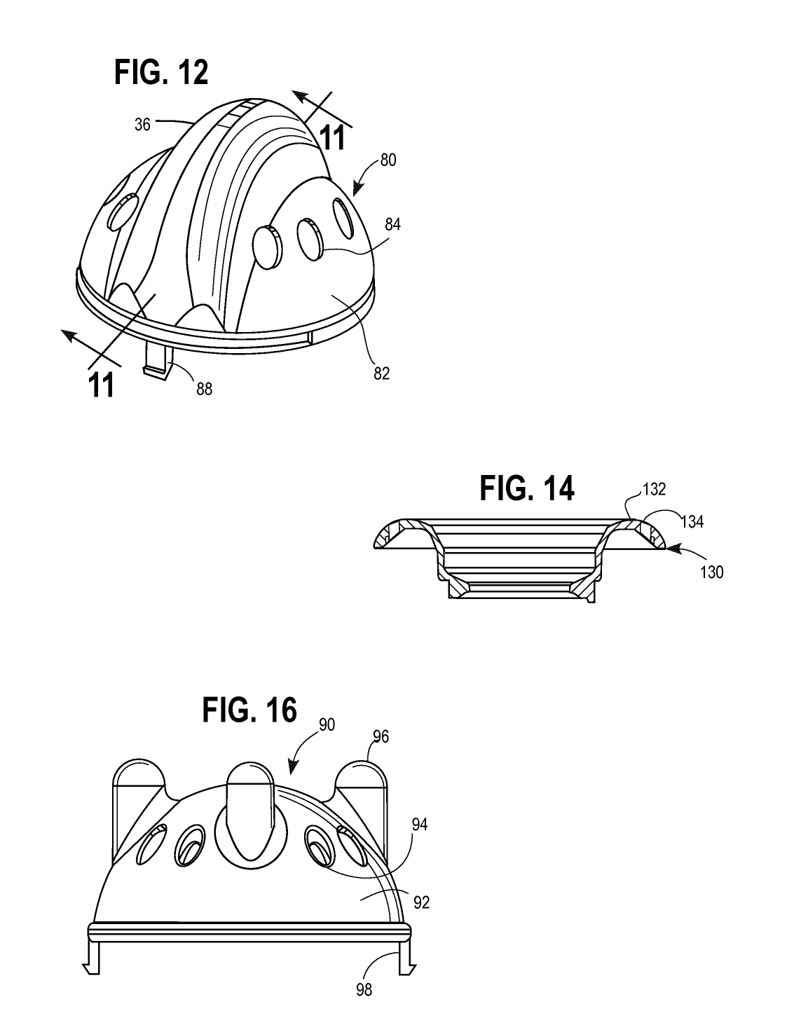

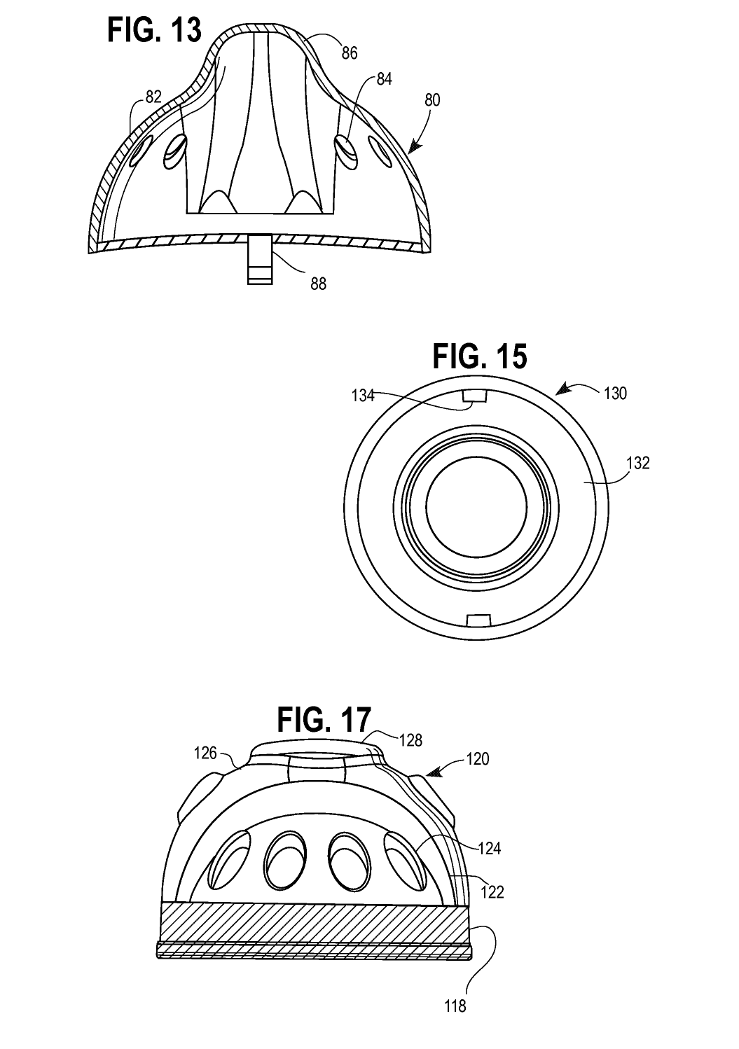

In yet another example, a massaging head 80 of FIGS. 12 and 13 may be provided with depending connectors 88 that are removably insertable into slots 134 formed in a flange 132 of a modified jet assembly 130, illustrated in FIGS. 14 and 15. The connectors 88 have a length selected to permit the massaging head 80 to reciprocate, pivot or vibrate relative to the jet assembly 130 when fluid flows from the jet assembly 130 through openings 84 of a dome portion 82 of the massaging head 80. Specifically, the connectors 88 are such that the massaging head is not tightly held against the jet assembly 130. The massaging head 80 includes a central raised rib 86 spanning the dome portion 82. Another example of a massaging head 90 having like connectors 98 is also illustrated in FIG. 16, and similarly has a dome shaped body 92 with a plurality of openings 94. The massaging head 90 includes a plurality of raised protuberances 96 extending outwardly from the dome portion 92. Both of these massaging heads 80 and 90 may be formed of a rigid plastic.

Turning to another example of a massaging head 120, illustrated in FIG. 17, the rigid plastic dome-shaped portion 122 includes a flexible, rubber base 118 that can be stretched to fit around the flange 26 of the massager 10, similar to the entirely rubber massaging head 50 illustrated in FIGS. 5 and 6. The massaging head 120 includes a plurality of apertures 124, as well as a central raised rib 126 which in turn has a plurality of raised protuberances 128.

In one example of the handheld massager 10, the first and second segments 20 and 16 may each have a length of between about 3 and 5 inches, and preferably about 4 inches. The total centerline length of the handheld massager 10 may be between about 7 and 12 inches, and preferably about 10 inches. The maximum diameter of the ovular first and second segments 20 and 16, as well as the intermediate curved segment 18, may each be between about 1 to 2.5 inches, and the first segment 20 may taper from about 2 inches adjacent the jet assembly 30 to about 1.5 inches adjacent the curved segment 18. Also, one of the first and second segments 20 and 16 may be curved, as illustrated with respect to the second segment 16 in FIG. 2 and described above, or both segments 20 and 16 may be curved. In one example, the angle θ between the first and second segments 20 and 16 of the housing 12 is between about 120 and 170 degrees, and more preferably about 140 degrees. These angles, as well as the other dimensions of the housing 12, can facilitate user postures in the hand/arm system that reduces exertion required by a user, such as if the wrist must be uncomfortably bent. In one example, the housing 12 is sized such that a user has about a 60 to 80 degree, and preferably about 70 degree, grasp angle compared to a thrust line. In addition, the segments 16, 18, and 20 may be contoured, with a plurality of suitable bulges and constructions to allow for multiple different hand positions with minimized tissue compression to the hand. The lack of a uniform surface, including the tapered ovular cross section and the curves, can reduce hand fatigue. The dimensions of the housing 12 are preferably selected to accommodate grasping by a large user group. For instance, the dimensions can be such that it will facilitate use by a certain large percentile range of female and male hands, including hand breadth and hand length.

The housing 12 may be formed from a pair of injection molded parts that mate along a centerline of the housing 12. The pair of parts may be joined via screws or other such fasteners via matching screw bosses 28 integrally formed in the parts. Other suitable ways of joining the parts may also be utilized, such as adhesive, welding, including ultrasonic welding, and snap fits. When screw bosses 28 are used, they may be positioned in spaced relation to each other to define narrowed sections in the interior of the housing 12. The narrowed sections, when sized slightly smaller than the diameter of the hose 8, can be used to facilitate maintaining the hose 8 in position relative to the housing 12. In addition or instead, the opening 22 at the end of the housing 12, opposite the end with the jet assembly 30, can have a dimension that also is slightly smaller than the diameter of the hose 8, and can thus be used to facilitate maintaining the hose 8 in position relative to the housing 12. One or more washers can be placed around the hose 8 at various intervals to assist in maintaining the position of the hose 8 internally in the housing 12.

From the foregoing, it will be appreciated that handheld massagers and methods of use are disclosed herein that provide for advantages in terms of function and ergonomics. However, the disclosure is not limited to the aspects and embodiments described hereinabove, or to any particular embodiments.

1. A handheld massager for fluid connection to a primary fluid source of a pool or spa to provide a remote source of fluid, the handheld massager comprising:
a housing having an end portion with a fluid jet to provide a remote source of fluid and a peripheral flange; and
a removable massaging head having at least a flexible base with an open end sized to fit around the peripheral flange of the housing and over the fluid jet to attach the massaging head to the end portion of the housing.

2. The handheld massager of claim 1, wherein open end of the massaging head has an inwardly extending flange surrounding an opening, the opening having a cross-sectional area less than a cross-sectional area of the peripheral flange of the end portion of the housing such that engagement of the inwardly extending flange of the massaging head and the peripheral flange of the end portion of the housing restricts removal of the massaging head from the housing.

3. The handheld massager of claim 2, wherein the massaging head has an exit opening opposite the open end.

4. The handheld massager of claim 3, wherein the massaging head has at least one protrusion on its surface.

5. The handheld massager of claim 4, wherein the massaging head is generally dome-shaped.

6. The handheld massager of claim 1, wherein the massaging head has an attachment pivotable with respect to the massaging head during fluid flow from the fluid jet.

7. The handheld massager of claim 1, wherein the end portion of the housing adjacent the peripheral flange has a cross-sectional area less than a cross-sectional area of the peripheral flange.

8. The handheld massager of claim 1, wherein a hose is connected to the fluid jet internal of the housing and the hose extends outwardly from an end of the housing opposite the fluid jet.

9. A method of providing vibratory and hydro therapy using a pool or spa, the method comprising:
hydraulically connecting a housing having an end portion with a fluid jet to a primary fluid source;
removably attaching a massaging head to the end portion of the housing, the massaging head having an exit opening; and
providing a fluid flow from the primary fluid source to the fluid jet and through the exit opening of the massaging head for hydro therapy and for vibrating the massaging head for vibratory therapy.

10. The method of claim 9, further including the step of rotating the fluid jet relative to the housing the fluid flow for vibrating the massaging head.

11. The method of claim 9, wherein the step of removable attaching the massaging head includes:
stretching an inwardly extending flange of the massaging head; and
sliding the stretched inwardly extending flange of the massaging head past an outwardly extending flange of the end portion of the housing.

12. The method of claim 9, further including removing the massaging head from the end portion of the housing and replacing the massaging head with a different massaging head.

13. The method of claim 9, further including pivoting the massaging head relative to the housing the fluid flow.

14. A handheld massager for fluid connection to a primary fluid source of a pool or spa to provide a remote source of fluid, the handheld massager comprising:
a housing having a generally circular first end segment configured for a first gripping position of the housing and a generally circular second end segment configured for a second gripping position of the housing, an axis of the first end segment being at an obtuse angle relative to an axis of the second end segment; and
a jet assembly disposed at an open end of the first end segment of the housing and having a portion disposed internal of the first end segment and a generally circular external flange disposed exteriorly of the first end segment, the external flange of the jet assembly having a diameter greater than a diameter of the first end segment adjacent the external flange of the jet assembly.

15. The handheld massager of claim 14, wherein the jet assembly includes a rotary jet nozzle configured to rotate in response to fluid flow through the nozzle.

16. The handheld massager of claim 14, further comprising a generally circular flange of the housing disposed between the first end segment and the external flange of the jet assembly.

17. The handheld massager of claim 16, wherein the flange of the housing has a diameter substantially the same as the diameter of the external flange of the jet assembly.

18. The handheld massager of claim 14, further comprising a generally circular curved segment disposed between the first and second segments of the housing.

19. The handheld massager of claim 18, wherein the ratio of the length of the first segment to the diameter of the first segment is approximately 2:1.

20. The handheld massager of claim 18, further comprising a hose extending through an open end of the second segment of the housing and operably connected to the portion of the jet assembly disposed internal of the first segment of the housing, the hose being connectable to the primary source of fluid to provide fluid to the handheld massager.

21. A handheld massager for fluid connection to a primary fluid source of a pool or spa to provide a remote source of fluid, the handheld massager comprising:
a housing having an end portion with a fluid jet to provide a remote source of fluid and a peripheral flange; and
a removable massaging head having means for connecting the massaging head relative to the housing to permit the massaging head to move relative to the housing during fluid flow through the massaging head.
